(19) United States
(12) Patent Application Publication
(10) Pub. No.: US 2022/0342899 A1
(43) Pub. Date: Oct. 27, 2022

(54) METHOD AND SYSTEM FOR PROVISIONING WORKFLOWS WITH PROACTIVE DATA TRANSFORMATION

(71) Applicant: EMC IP Holding Company LLC, Hopkinton, MA (US)

(72) Inventors: John S. Harwood, Boston, MA (US); Robert Anthony Lincourt, JR., Franklin, MA (US); Bhavesh Govindbhai Patel, Austin, TX (US); William Price Dawkins, Lakeway, TX (US); William Jeffery White, Plano, TX (US)

(21) Appl. No.: 17/236,762

(22) Filed: Apr. 21, 2021

(51) Int. Cl. G06F 16/25

(52) U.S. Cl. CPC G06F 16/258

(57) ABSTRACT

Techniques described herein relate to a method for provisioning workflows with data transformation services. The method may include receiving, by a platform controller associated with a first domain, workflow information associated with a portion of a workflow to be deployed in a device ecosystem, where the portion of the workflow includes a first subportion of the workflow; identifying an output intent associated with data of the first subportion of the workflow; making a first determination that the output intent is associated with a data transformation of the data; making a second determination that the first domain is able to perform the data transformation; and establishing data transformation services using resources of the first domain; and initiating performance of the first subportion of the workflow, where executing the first subportion of the workflow includes executing the data transformation services.

### BACKGROUND

Computing devices often exist in complex ecosystems of devices in which data exists and/or is generated. Such data may be used and/or operated on to produce any number of results. Such operations are often performed by workflows that include any number of services, each using any number of applications, modules, etc. It may be advantageous to deploy all or portions of such workflows within certain portions of the ecosystem of devices. However, as the complexity of such an ecosystem increases (e.g., more data, more devices, etc.), it may become difficult to determine where to deploy workflows, and how to efficiently do so once an execution environment is determined.

### SUMMARY

In general, certain embodiments described herein relate to a method for provisioning workflows with data transformation services. The method may include receiving, by a platform controller associated with a first domain, workflow information associated with a portion of a workflow to be deployed in a device ecosystem, where the portion of the workflow includes a first subportion of the workflow; identifying an output intent associated with data of the first subportion of the workflow; making a first determination that the output intent is associated with a data transformation of the data; making a second determination that the first domain is able to perform the data transformation; and establishing data transformation services using resources of the first domain; and initiating performance of the first subportion of the workflow, where executing the first subportion of the workflow includes executing the data transformation services.

In general, certain embodiments described herein relate to a non-transitory computer readable medium that includes computer readable program code, which when executed by a computer processor enables the computer processor to perform a method for provisioning workflows with data transformation services. The method may include receiving, by a platform controller associated with a first domain, workflow information associated with a portion of a workflow to be deployed in a device ecosystem, where the portion of the workflow includes a first subportion of the workflow; identifying an output intent associated with data of the first subportion of the workflow; making a first determination that the output intent is associated with a data transformation of the data; making a second determination that the first domain is able to perform the data transformation; and establishing data transformation services using resources of the first domain; and initiating performance of the first subportion of the workflow, where executing the first subportion of the workflow includes executing the data transformation services.

In general, certain embodiments described herein relate to a system for deploying workflows. The system may include a service controller of a federated controller for a device ecosystem. The system may also include a platform controller of a first domain, comprising a processor and memory, and configured to receive workflow information associated with a portion of a workflow to be deployed in a device ecosystem, where the portion of the workflow includes a first subportion of the workflow; identify an output intent associated with data of the first subportion of the workflow; make a first determination that the output intent is associated with a data transformation of the data; make a second determination that the first domain is able to perform the data transformation; and establish data transformation services using resources of the first domain; and initiate performance of the first subportion of the workflow, where executing the first subportion of the workflow includes executing the data transformation services.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2A shows a flowchart in accordance with one or more embodiments of the invention.

FIG. 2B shows a flowchart in accordance with one or more embodiments of the invention.

FIG. 3 shows an example in accordance with one or more embodiments of the invention.

FIG. 4 shows a computing system in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, embodiments described herein relate to methods, systems, and non-transitory computer readable mediums storing instructions for provisioning workflows, or portions thereof, that include data transformation services.

In one or more embodiments, as device ecosystems grow in size and complexity (e.g., from cloud to core to edge to client), connecting more diverse devices generating more data, the need to be able to inventory and characterize the connectivity is required in order to support complex workflows. In one or more embodiments, as the overall application workflow extends within a device ecosystem to capture, process, analyze, or otherwise use data, fitting the services of the application workflow to the capabilities of the various portions of the ecosystem is required. Such fitting may allow for meeting the service level agreement (SLA) for the application workflow and the services used in building the workflow, which may be achieved by provisioning work to portions of the ecosystem having necessary capabilities, capacity, and/or data, using mapping relationships between devices. In one or more embodiments, the device ecosystem from client to edge to core to cloud can be mapped into a graph, database, etc., with elements discovered and relationships established and maintained for queries made to determine where one or more portions of a given workflow should be deployed.

Such a graph or database may include ecosystem information in various levels of abstraction. For example, each portion of an ecosystem (e.g., client, far edge, near edge, core, cloud, etc.) may have one or more service controllers. In one or more embodiments, the services controllers operate collectively as a federated controller for the ecosystem. Additionally, in one or more embodiments, each domain within a given portion of an ecosystem may have a platform controller.

In one or more embodiments, the service controllers receive, from platform controllers in their ecosystem portion, capabilities and capacity information, and also receive the same from other service controllers in the federated controller for their respective one or more platform controllers. Such capability and capacity information shared among the service controllers of the federated controller, along with information related to connectivity between different portions of the ecosystem, may be one level of the graph/database of the ecosystem.

In one or more embodiments, each platform controller in an ecosystem obtains and stores more detailed information of the device set of the domain with which it is associated, including, but not limited to, details related to topology, connection bandwidth, processors, memory, storage, data stored in storage, network configuration, domain accelerators (e.g., graphics processing units (GPUs)), deployed operating systems, programs and applications, etc. In one or more embodiments, the more detailed information kept by the various platform controllers represents a different layer of the graph or database of the ecosystem. Thus, in one or more embodiments, the service controllers of the federated controller of an ecosystem have a map of the capabilities and capacity of the various portions of the ecosystem, while the underlying platform controllers have a more detailed map of the actual resources within a given domain device set with which they are associated.

In one or more embodiments, any service controller of the federated controller of an ecosystem may receive a request to execute a workflow (e.g., from a console accessing the service controller). In one or more embodiments, the workflow may be received as or transformed into a directed acyclic graph (DAG). For example, a workflow may be received as a YAML Ain′t Markup Language (YAML) file that is a manifest representing a set of interconnected services. In one or more embodiments, the service controller decomposes the DAG into workflow portions, such as services required, data needed, etc. In one or more embodiments, one or more such workflow portions may be identified as an anchor point. In one or more embodiments, the service controller then queries the graph (e.g., by performing a depth first or breadth first search) or database (e.g., using database query techniques) representing the ecosystem to determine what portion of the ecosystem is appropriate for the one or more anchor points (e.g., where the necessary data is or is generated from, where the infrastructure exists to execute a given service, etc.).

In one or more embodiments, once the anchor point has been identified, the service controller may then map it to the appropriate ecosystem portion, and map the other services of the workflow to portions of the ecosystem relative to the anchor point based on locality between the portions of the ecosystem and the anchor point, thereby minimizing the cost of data transfer as much as is possible. In one or more embodiments, the various workflow portions and workflow information associated with the various workflow portions are then provided to platform controllers of the domains to which the workflow portions were mapped, along with any related constraints derived from the workflow or SLA of the workflow.

In one or more embodiments, upon receiving the workflow portion and workflow information from the service controller, a platform controller identifies an output intent specified in the workflow information. The platform controller then determines whether the output intent is associated with a data transformation. If the output intent is associated with a data transformation, the platform controller makes a further determination, using capability and capacity information associated with the domain corresponding to the platform controller, whether the domain corresponding to the platform controller is able to perform the data transformation. If the platform controller determines that the that the domain is able to perform the data transformation, then the platform controller provisions devices of the domain to perform data transformation services associated with the data transformation along with the portion of the workflow. As a result, when the workflow portion is executed on the domain, data transformation services perform the data transformation. However, if the platform controller determines that the output intent is not associated with a data transformation or that the domain is not able to perform the data transformation, then the platform controller may provision the devices of the domain to perform solely the portion of the workflow. As a result, no data transformation services are performed during the execution of the workflow.

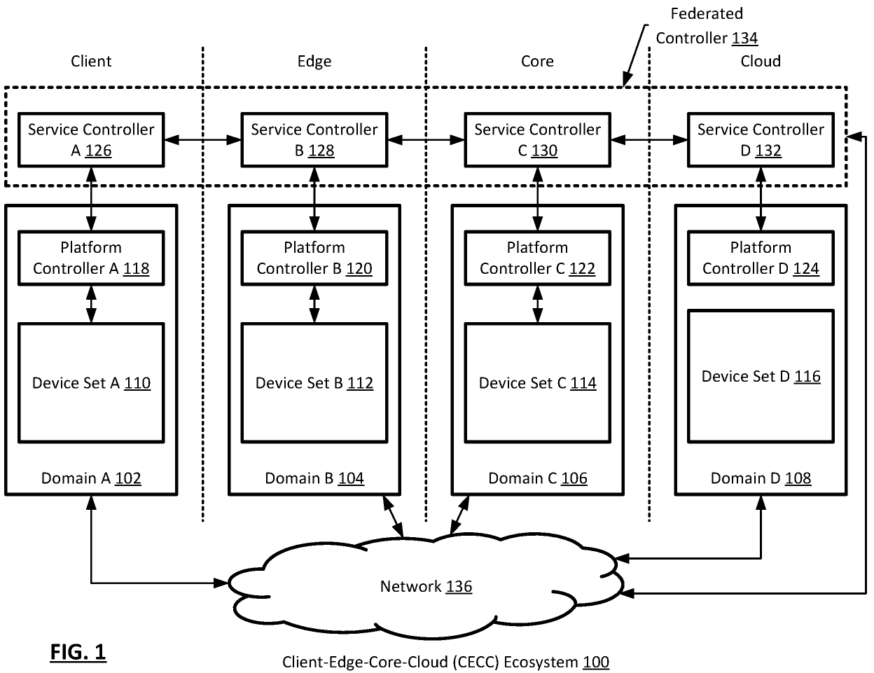

FIG. 1 shows a diagram of a system in accordance with one or more embodiments described herein. The system may include client-edge-core-cloud (CECC) ecosystem (100). CECC ecosystem (100) may include domain A (102), domain B (104) domain C (106) and domain D (108). Domain A (102) may include platform controller A (118) and device set A (110). Domain B (104) may include platform controller B (120) and device set B (112). Domain C (106) may include platform controller C (122) and device set C (114). Domain D (108) may include platform controller D (124) and device set D (116). Domain A (102) may be operatively connected to (or include) service controller A (126). Domain B (104) may be operatively connected to (or include) service controller B (128). Domain C (106) may be operatively connected to (or include) service controller C (130). Domain D (108) may be operatively connected to (or include) service controller D (132). Service controller A (126), service controller B (128), service controller C (130), and service controller D (132) may collectively be a federated controller (134). All or any portion of any device or set of devices in CECC ecosystem (100) may be operatively connected to any other device or set of devices via network (136). Each of these components is described below.

In one or more embodiments, CECC ecosystem (100) may be considered a hierarchy of ecosystem portions. In the example embodiment shown in FIG. 1, CECC ecosystem (100) includes a client portion, an edge portion, a core portion, and a cloud portion. However, CECC ecosystem (100) is not limited to the exemplary arrangement shown in FIG. 1. CECC ecosystem (100) may have any number of client portions, each operatively connected to any number of edge portions, which may, in turn, be operatively connected to any number of core portions, which may, in turn, be connected to one or more cloud portions. Additionally, a given CECC ecosystem (100) may have more or less layers without departing from the scope of embodiments described herein. For example, the client portion may be operatively connected to the core portion, or the cloud portion, without an intervening edge portion. As another example, there may be a far edge portion and a near edge portion of ecosystem (100). One of ordinary skill in the art will recognize that there are many possible arrangements of the CECC ecosystem (100) other than the example hierarchy shown in FIG. 1.

In one or more embodiments, domain A (100) is a portion of CECC ecosystem (100) in the client portion of CECC ecosystem (100). Similarly, domain B (104), domain C (106) and domain D (108) are in the edge portion, the core portion, and the cloud portion, respectively.

In one or more embodiments, domain A (102) includes device set A (110). In one or more embodiments, device set A (110) includes any number of computing devices (not shown). In one or more embodiments, a computing device is any device, portion of a device, or any set of devices capable of electronically processing instructions and may include any number of components, which include, but are not limited to, any of the following: one or more processors (e.g., components that include integrated circuitry) (not shown), memory (e.g., random access memory (RAM)) (not shown), input and output device(s) (not shown), non-volatile storage hardware (e.g., solid-state drives (SSDs), hard disk drives (HDDs) (not shown)), one or more physical interfaces (e.g., network ports, storage ports) (not shown), any number of other hardware components (not shown), accelerators (e.g., GPUs) (not shown), sensors for obtaining data, and/or any combination thereof.

Examples of computing devices include, but are not limited to, a server (e.g., a blade-server in a blade-server chassis, a rack server in a rack, etc.), a desktop computer, a mobile device (e.g., laptop computer, smart phone, personal digital assistant, tablet computer, automobile computing system, and/or any other mobile computing device), a storage device (e.g., a disk drive array, a fibre/fiber channel storage device, an Internet Small Computer Systems Interface (iSCSI) storage device, a tape storage device, a flash storage array, a network attached storage device, etc.), a network device (e.g., switch, router, multi-layer switch, etc.), a hyperconverged infrastructure, a cluster, a virtual machine, a logical container (e.g., for one or more applications), and/or any other type of device with the aforementioned requirements.

In one or more embodiments, any or all of the aforementioned examples may be combined to create a system of such devices. Other types of computing devices may be used without departing from the scope of the embodiments described herein.

In one or more embodiments, the non-volatile storage (not shown) and/or memory (not shown) of a computing device or system of computing devices may be one or more data repositories for storing any number of data structures storing any amount of data (i.e., information). In one or more embodiments, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more embodiments, any non-volatile storage (not shown) and/or memory (not shown) of a computing device or system of computing devices may be considered, in whole or in part, as non-transitory computer readable mediums, which may store software and/or firmware.

Such software and/or firmware may include instructions which, when executed by the one or more processors (not shown) or other hardware (e.g., circuitry) of a computing device and/or system of computing devices, cause the one or more processors and/or other hardware components to perform operations in accordance with one or more embodiments described herein.

The software instructions may be in the form of computer readable program code to perform, when executed, methods of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium. As discussed above, embodiments of the invention may be implemented using computing devices.

In one or more embodiments, such computing devices may be operatively connected to other computing devices of device set A (110) in any way, thereby creating any topology of computing devices within device set A (110). In one or more embodiments, one or more computing devices in device set A (110) may be operatively connected to any one or more devices in any other portion of CECC ecosystem (100). Such operative connections may be all or part of a network (136). A network (e.g., network (136)) may refer to an entire network or any portion thereof (e.g., a logical portion of the devices within a topology of devices). A network may include a data center network, a wide area network, a local area network, a wireless network, a cellular phone network, and/or any other suitable network that facilitates the exchange of information from one part of the network to another. A network may be located at a single physical location, or be distributed at any number of physical sites. In one or more embodiments, a network may be coupled with or overlap, at least in part, with the Internet.

In one or more embodiments, although shown separately in FIG. 1, the network (136) may include any number of devices within any device set (e.g., 110, 112, 114, 116) of CECC ecosystem (100), as well as devices external to, or between, such portions of CECC ecosystem (100). In one or more embodiments, at least a portion of such devices are network devices (not shown). In one or more embodiments, a network device is a device that includes and/or is operatively connected to persistent storage (not shown), memory (e.g., random access memory (RAM)) (not shown), one or more processor(s) (e.g., integrated circuits) (not shown), and at least two physical network interfaces, which may provide connections (i.e., links) to other devices (e.g., computing devices, other network devices, etc.). In one or more embodiments, a network device also includes any number of additional components (not shown), such as, for example, network chips, field programmable gate arrays (FPGAs), application specific integrated circuits (ASICs), indicator lights (not shown), fans (not shown), etc. A network device may include any other components without departing from the scope of embodiments described herein. Examples of a network device include, but are not limited to, a network switch, a router, a multilayer switch, a fibre channel device, an InfiniBand® device, etc. A network device is not limited to the aforementioned specific examples.

In one or more embodiments, a network device includes functionality to receive network traffic data units (e.g., frames, packets, tunneling protocol frames, etc.) at any of the network interfaces (i.e., ports) of a network device and to process the network traffic data units. In one or more embodiments, processing a network traffic data unit includes, but is not limited to, a series of one or more lookups (e.g., longest prefix match (LPM) lookups, forwarding equivalence class (FEC) lookups, etc.) and corresponding actions (e.g., forward from a certain egress port, add a labeling protocol header, rewrite a destination address, encapsulate, etc.). Examples of network traffic data unit processing include, but are not limited to, performing a lookup to determine: (i) whether to take a security action (e.g., drop the network traffic data unit); (ii) whether to mirror the network traffic data unit; and/or (iii) how to route/forward the network traffic data unit in order to transmit the network traffic data unit from an interface of the network device. In one or more embodiments, network devices are configured to participate in one or more network protocols, which may include discovery schemes by which a given network device may obtain information about all or any of the network topology in which the network device exists. Such discovery schemes may include sharing of information between network devices, and may also include providing information to other devices within CECC ecosystem (100), such as, for example, service controllers and/or platform controllers (discussed below).

In one or more embodiments, any or all of the devices in device set A (110) may form one or more virtualization environments (not shown). In one or more embodiments, a virtualization environment is any environment in which any number of computing devices are subject, at least in part, to a shared scheme pooling compute resources for use in deploying virtualized computing device instances (e.g., VMs, containers, emulators, etc.), which may be used in any arrangement to perform all or any portion of any work requested within a domain.

In one or more embodiments, domain A (102) also includes platform controller A (118). In one or more embodiments, platform controller A (112) is any computing device (described above), or any portion of any computing device. In one or more embodiments, platform controller A (118) executes as a service. In one or more embodiments, platform controller A (118) includes functionality to discover details of device set A (110). Such details include, but are not limited to: how devices are connected; physical location of devices; network distance between devices within domain A (102) and network distance between devices with domain A (102) and devices in other domains (e.g., 104, 106, 108); what resources a device has (e.g., processors, memory, storage, networking, accelerators, etc.), how much capacity of a device or set of devices are used; what operating systems are executing on devices; how many virtual machines or other virtual computing instances exist; what data exists and where it is located; and/or any other information about devices in device set A (110).

In one or more embodiments, based on the information discovered by platform controller A (118) about device set A (110), platform controller A determines what capabilities, including data transformation services, device set A (110), or any portion thereof, may perform. In one or more embodiments, the data transformation service may include modifying, based on an output intent, data generated and/or otherwise obtained during the performance of a workflow portion for use in a subsequent workflow portion. The data transformations may include compression, deduplication, encryption, data realignment for different types of central processing units, graphics processing units, etc., and any other data transformation without departing from the invention. In one or more embodiments, a capability is any one or more actions, operations, functionality, stored data, ability to obtain data from any number of data sources, compute resources to perform certain tasks, etc. Examples of capabilities include, but are not limited to, inference, training for machine learning, implementing in-memory databases, having a particular dataset (e.g., video and images from stores of a certain company in a certain region of the country), performing classification, data analysis, etc. Embodiments described herein are not limited to the aforementioned examples. In one or more embodiments, platform controller B (120), platform controller C (122), and platform controller D (124) are also computing devices (described above), and perform functionality similar to that of platform controller A (118) for their respective domains (i.e., domain B (104), domain C (106), and domain D (108)).

In one or more embodiments, each domain (e.g., 102, 104, 106, 108) in CECC ecosystem (100) includes a device set (e.g., 110, 112, 114, 116) and a platform controller (e.g., 118, 120, 122, 124). In one or more embodiments, each device set is a set of computing devices, such as is discussed above in the description of device set A. However, the set of computing devices in different device sets may be different, and may be particular to the portion (e.g., client, edge, cloud, core) of CECC ecosystem (100) that the device set is in. For example, the client portion of CECC ecosystem (100) may include sensors collecting data, controllers controlling the sensors, desktop devices, mobile computing devices, etc. Other data sets may include different computing devices. For example, the edge portion of CECC ecosystem (100) may have a device set that include servers with more compute ability than devices in the client portion. Similarly, the core portion of CECC ecosystem (100) may include more powerful (e.g., having more compute resources) devices, a greater quantity of more powerful devices, specific architectures of sets of devices for performing certain tasks, etc. Also similarly, the cloud portion of CECC ecosystem (100) may include still more and different devices configured and deployed in different ways that the other portions of CECC ecosystem (100).

Additionally, although not shown in FIG. 1, the CECC ecosystem (100) may be arranged in a hierarchy. For example, a single cloud portion may be operatively connected to any number of core portions, each of which may be connected to any number of edge portions, each of which may be connected to any number of client portions. The particular device set (110, 112, 114, 116) in any given portion of CECC ecosystem (100) may determine what capabilities the domain (102, 104, 106, 108) in which the device set exists is suited to perform, which is known to and/or determined by the platform controller for the domain (102, 104, 106, 108).

In one or more embodiments, each platform controller (118, 120, 122, 124) is operatively connected to a respective service controller (126, 128, 130, 132). In one or more embodiments, the service controllers (126, 128, 130, 132) are implemented as computing devices, where the computing devices may be embodiments of the computing devices discussed above. Any portion of CECC ecosystem (100) may include any number of service controllers (126, 128, 130, 132), each of which may be operatively connected to any number of platform controllers (118, 120, 122, 124) in any number of domains (102, 104, 106, 108) in a given ecosystem portion (e.g., client, edge, cloud, core). In one or more embodiments, each service controller (126, 128, 130, 132) is also operatively connected to the other service controllers (126, 128, 130, 132) in CECC ecosystem (100). In one or more embodiments, the operatively connected service controllers (126, 128, 130, 132) of CECC ecosystem (100) form federated controller (134) for CECC ecosystem (100). In one or more embodiments, federated controller (134) functions as a distributed service for deploying workflows within CECC ecosystem (100). In one or more embodiments, any service controller of federated controller (134) may be accessed to request provisioning of a workflow. In one or more embodiments, each service controller (126, 128, 130, 132) receives, from operatively connected platform controllers within the same portion of CECC (100), information about what capabilities, including data transformation services, underlying device sets of a domain can perform, how much capacity is available on the device set within a given domain (which may be updated on any update schedule), geographical distances between devices, network distances between devices, and/or any other information or metadata that may be useful to determine whether a portion of a workflow should be or can be provisioned within a given domain. In one or more embodiments, each service controller of federated controller (134) also shares the information with each other service controller of federated controller (134). Collectively, the shared information may be organized as a graph, or database, or any other data construct capable of storing such information and being queried to find such information. Such a graph or database may be a distributed data construct shared between the collection of service controllers of federated controller (134).

While FIG. 1 shows a configuration of components, other configurations may be used without departing from the scope of embodiments described herein. Accordingly, embodiments disclosed herein should not be limited to the configuration of components shown in FIG. 1.

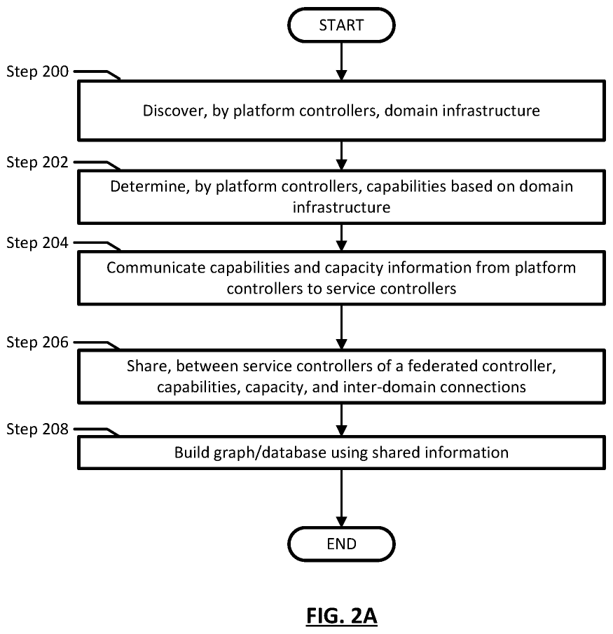

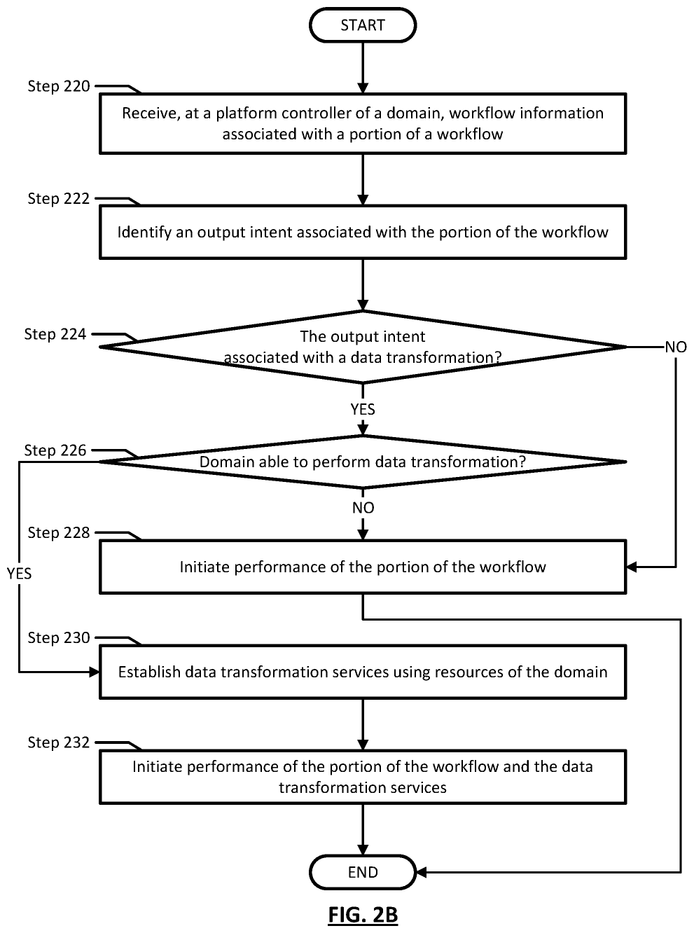

FIG. 2A shows a flowchart describing a method for discovering and obtaining information about an ecosystem of devices to be stored in a data construct for future queries when provisioning workflows in accordance with one or more embodiments disclosed herein.

While the various steps in the flowchart shown in FIG. 2A are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In Step 200, each platform controller in a given ecosystem discovers information about the device set in the domain in which the platform controller exists. Such information may include the topology of the devices, the computing resources of the devices, physical locations of the devices, network information associated with the devices, configuration details of the devices, operating systems executing on the devices, the existence of any number of virtualized computing device instances, the storage location of any number of datasets, how much of the capacity of any one or more devices is being used and/or has available, etc.

In one or more embodiments, any mechanism or scheme for discovering such information may be used, and any number of different mechanisms and/or schemes may be used to obtain various types of information. For example, the platform controller may request virtualization infrastructure information from one or more virtualization controllers, determine domain network topology by participating in and/or receiving information shared among domain network devices pursuant to one or more routing protocols, perform queries to determine quantity and type of processors, amount of memory, quantity of GPUs, amount of storage, number of network ports, etc. for servers, determine what type of information is being collected and/or processed by various sensors, controllers, etc., determine where datasets of a particular type or purpose are stored by communicating with one or more storage controllers, etc. Any other form of discovery may be performed by the platform controllers without departing from the scope of embodiments described herein.

In Step 202, based on the information discovered in Step 200, a given platform controller determines what capabilities, including data transformation services, the device set of a domain has. In one or more embodiments, determination of the capabilities of the device set, or any portion thereof, may be performed in any manner capable of producing one or more capabilities that a given device set, connected and configured in a particular way, may perform. For example, the platform controller may execute a machine learning algorithm that has been trained to identify certain capabilities of a domain set based on the set of information about a given device set of a domain.

In Step 204, the capabilities of the domain determined in Step 202 are communicated from the platform controller to an operatively connected service controller, along with information about the currently available capacity of the domain. For example, a platform controller may communicate to a service controller that the domain has the capability to perform inference, to analyze data in a particular way, to train certain types of machine learning algorithms, has the sensors to obtain certain types of data, etc. At the same time, the platform controller may also communicate, for example, that currently 27% of the resources of the domain, or any potion therein, are available to perform additional work. In one or more embodiments, the platform controller may also communicate any other information about the domain to the service controller, such as that the domain has (or has sensors to obtain) particular datasets that may be used for a particular purpose (e.g., training a certain type of machine learning algorithm).

In Step 206, each of the service controllers of the federated controller of an ecosystem shares the capabilities, capacity, and other information with each other. Sharing information may include sending some or all of the information to the other service controllers, and/or storing the information in a location that is commonly accessible by the service controllers. In one or more embodiments, the service controllers also share information about how the different portions of the ecosystem are operatively connected, including types of network devices, network topologies, network distances, and/or geographic distances between different portions of the ecosystem. For example, the service controllers may use information gained from devices executing a border gateway protocol (BGP) to obtain topology information for the ecosystem.

In Step 208, the federated controller of the ecosystem builds a graph or database using the information communicated from the platform controllers in Step 204 or otherwise obtained and shared in Step 208. In one or more embodiments, the graph or database is stored as a distributed data construct by the service controllers of the federated controller, and may be distributed in any way that a set of information may be divided, so long as it is collectively accessible by each of the service controller of the federated controller. In one or more embodiments, the graph or database is stored in a form which may be queried to find information therein when determining how to provision portions of a workflow for which execution is requested. Receiving a request to execute a workflow, querying the graph or database, and provisioning the workflow portions to various domains in the various portions of the ecosystem are discussed further in the description of FIG. 2B, below.

FIG. 2B shows a flowchart describing a method for provisioning workflows within a device ecosystem in accordance with one or more embodiments disclosed herein.

While the various steps in the flowchart shown in FIG. 2B are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In Step 220, a platform controller receives workflow information associated with a portion of a workflow. In one or more embodiments, the platform controller receives the workflow information, directly or indirectly, from at least one service controller of the federated controller. In one or more embodiments, the workflow information is provided directly to the platform controller by a service controller in the same ecosystem portion as the platform controller. In one or more embodiments, the workflow information is provided to the platform controller using any appropriate method of data transmission. As an example, the service controller may communicate the workflow information as network data traffic units over a series of network devices that operatively connect the platform controller and the relevant service controller. In one embodiment of the invention, the workflow information is a data structure that includes information that specifies services to be performed to execute the portion of the workflow assigned to the platform controller, and an output intent. The workflow information may specify one or more output intents without departing from the invention.

In Step 222, the platform controller identifies an output intent associated with the portion of the workflow. In one or more embodiments, the platform controller identifies that output intent using the workflow information obtained in Step 222. In one or more embodiments, the output intent includes information regarding how data generated and/or otherwise obtained may be used in subsequent portions of the workflow associated with another domain and/or subportions of the workflow executed within the same domain. The information included in the output intent may specify the resources that will be used to further process the data at the next portion and/or subportion of the workflow, the services that use the data as inputs, domains in which the data is to be transmitted, data transformations performed in subsequent portions and subportions of the workflow, and/or any other information regarding the manner in which the data is to be consumed, operated on, used, etc. As an example, an output intent associated with a portion of the workflow which involves obtaining image data from cameras may specify the domain in which the image data is to be transmitted, the services that may be executed using the image data (e.g., inferencing, machine learning algorithms, etc.), and the types of processors used to execute the aforementioned services (e.g., an x86 microprocessor, an ARM processor, an FPGA, a graphics processing unit, etc.).

In Step 224, the platform controller makes a determination as to whether the output intent is associated with a data transformation. In one or more embodiments, the platform controller uses the information specified by the output intent to determine whether a data transformation is associated with the output intent. As an example, the output intent may specify that data generated during a portion of the workflow is to be transmitted to a domain, where graphics processing units may be used to execute a service using the data. The output intent may additionally or alternatively specify that the data is to be encrypted prior to transmission to the domain, and/or that a particular format of the data is compatible with the graphics processing units, which is different than the format in which the data is generated. The platform controller may identify as data transformations the encryption, realignment, etc. of data which may require reformatted or otherwise transformed data compatible with the graphics processing units. Based on the identification of such data transformations, the platform controller may determine that the output intent is associated with a data transformation.

In a further example, the output intent may specify that data generated during a portion of the workflow using a processor included in the domain is to be replicated using the same processor and the resulting replications are to be stored in storage included in the domain. The output intent may further specify that a particular format of the data is compatible with the processor, which is the same as the format in which the data is generated. The platform controller may not identify any data transformations in the output intent. As a result, the platform controller may determine that the output intent is not associated with a data transformation.

In one or more embodiments, if the platform controller determines that the output intent is associated with a data transformation, then the method proceeds to Step 226. In one or more embodiments, if the platform controller determines that the output intent is not associated with a data transformation, then the method proceeds to step 228.

In Step 226, the platform controller makes a determination as to whether the domain is able to perform the data transformation. In one or more embodiments, the service controller determines whether the domain associated with the platform controller is able to perform the data transformation using the capability and capacity information associated with the domain. In one or more embodiments of the invention, if the capability and capacity information indicates that the domain is able to perform the data transformation, then the platform controller may determine that the domain is able to perform the data transformation. In one or more embodiments, if the capability and capacity information indicates that the domain is not able to perform the data transformation, then the platform controller may determine that the domain is not able to perform the data transformation. In one or more embodiments, the output intent may specify one or more data transformations. In such scenarios, the platform controller may determine whether the domain is able to perform each data transformation using the methods described above.

In one or more embodiments of the invention, if the platform controller determines that the domain is able to perform the data transformation, then the method proceeds to Step 230. In one or more embodiments of the invention, if the platform controller determines that the domain is not able to perform the data transformation, then the method proceeds to step 228.

In Step 228, the platform controller initiates the performance of the portion of the workflow. In one or more embodiments, the platform controller may provision and/or configure devices included in the domain corresponding to the platform controller to perform the portion of the workflow in a way that satisfies the constraints specified by the workflow information (e.g., requirements to meet the SLA). In one or more embodiments, once all or any portion of the device set of the one or more domains has been configured to perform the portion of the workflow, the workflow is executed.

In Step 230, the platform controller establishes data transformation services using resources of the domain. In one or more embodiments, the platform controller may configure devices included in the domain corresponding to the platform controller to perform the data transformation services in a way that satisfies the data transformation specified by the output intent of the workflow information. In one or more embodiments, the platform controller may configure any number of devices in the domain to perform any number of data transformation services to satisfy any number of data transformations without departing from the invention.

In Step 232, the platform controller initiates the performance of the portion of the workflow and the data transformation services. In one or more embodiments, the platform controller may configure devices included in the domain corresponding the platform controller to perform the workflow in a way that satisfies the constraints specified by the workflow information. In one or more embodiments, once all or any portion of the device set of the one or more domains has been configured to perform the workflow and the data management services, the portion of the workflow is executed, and the data transformation services are performed during the execution of the portion of the workflow.

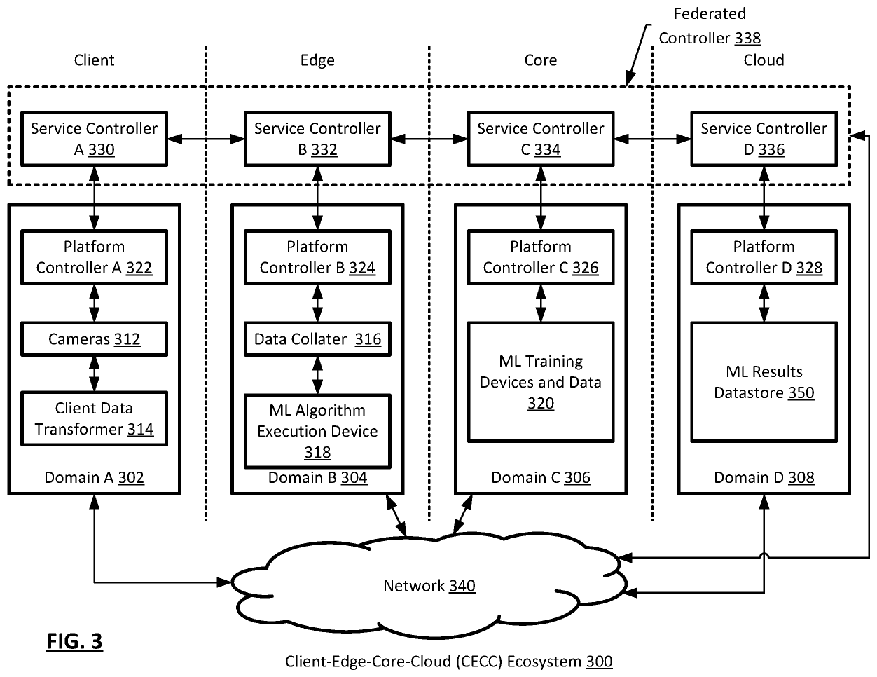

FIG. 3 shows an example in accordance with one or more embodiments described herein. The following example is for explanatory purposes only and not intended to limit the scope of embodiments described herein. Additionally, while the example shows certain aspects of embodiments described herein, all possible aspects of such embodiments may not be illustrated in this particular example. This example is intended to be a simple example to illustrate, at least in part, concepts described herein. One of ordinary skill will appreciate that a real-world use of embodiments described herein may use a device ecosystem organized and interconnected in any manner, and that any number of different workflows to achieve any number of different results may be deployed in such an ecosystem of devices.

Referring to FIG. 3, consider a scenario in which a car manufacturer has cameras deployed on a mobile self-driving cars to monitor events encountered by the car during a trip while on a trip. Based on the events, a car manufacturer wants to use the video data to determine whether the car responds correctly to the events (e.g., changing lanes, passing other cars, etc.). To achieve this goal, the car manufacture needs to train a machine learning algorithm that has been trained to recognize when video data of events indicate that the car has incorrectly responded to events, and the ability to execute the trained algorithm using the video obtained by the cameras on the cars.

In such a scenario, the store will utilize CECC ecosystem (300), which includes domain A (302) in a client portion of the ecosystem, domain B (304) in an edge portion of the ecosystem, domain C (306) in a core portion of the ecosystem, and domain D (308) in a cloud portion of the ecosystem. Domain A (302) includes platform controller A (322), a client data transformer (314) and cameras (312). Domain B (304) includes platform controller B (324), data collater (316), and machine learning (ML) algorithm execution device (318). Domain C (306) includes platform controller C (326) and ML training devices and data (320). Domain D (308) includes platform controller D (328) and ML results datastore (350). Domain A (302) is operatively connected to service controller A (330). Domain B (304) is operatively connected to service controller B (332). Domain C (306) is operatively connected to service controller C (334). Domain D (308) is operatively connected to service controller D (336). Service controller A (330), service controller B (332), service controller C (334), and service controller D (336) collectively are federated controller (338). All or any portion of any device or set of devices in CECC ecosystem (300) may be operatively connected to any other device or set of devices via network (340).

The client portion of the ecosystem exists in the car as cameras (312) on the car, and the associated computing devices for capturing the video data and transforming the video data (i.e., client data transformer (314)), preprocessing video data (i.e., data preprocessor (314)), and offloading video data (i.e., data offloader (316)). The edge portion of the ecosystem exists at the car manufacturing plant, and includes computing devices for collating the data (i.e., data collater (316)) and computing devices for executing the trained ML algorithm (i.e., ML algorithm execution device (318)). The car manufacturer is part of a national chain that has a number of data centers across the country that collectively make up the core portion of the car manufacturer device ecosystem. Domain C (306) is in a data center of the core portion that is located in the same region as the plant. The cloud portion of the ecosystem is used for storing information relevant to the chain of stores, for historical purposes, as well as being the location from which all self-driving car updates for the car manufacturer are made.

When the car manufacturer seeks to implement the new performance management scheme, it submits the workflow as a YAML file to service controller B (332), which is implemented on a server located at the car manufacturing plant and accessed via a console from a computer of the manager of the car manufacturer. Service controller B (332) converts the YAML file into a DAG. In the DAG, the video data must be obtained from the cameras (312) on the car, the ML algorithm must be trained using video data the car manufacturer owns. The trained ML algorithm must be provided to the ML algorithm execution device (318) located in the edge portion of the ecosystem that is also at the store. The image data from the cameras (312) must be collated and provided to ML algorithm execution device (318). Finally, the results of executing the ML algorithm based on the video data must be stored in the cloud so that the required self-driving car updates may be made.

Service controller B (332) decomposes the DAG, and identifies the video acquisition from the cameras on the car as the anchor point. Service controller B (332) then performs a search of a previously constructed graph of capabilities and capacity of the various domains in the ecosystem, and identifies domain A (302) as including the relevant cameras (312). Domain A (302) and the cameras (312) therein thus become the anchor point for the workflow. Service controller B (332) continues the search based on the anchor point, by searching within portions of the ecosystem in the same region of the country as the location of the car manufacturing plant, and identifies that domain B (304), which is located at the car manufacturing plant, has expressed through platform controller B (324) and service controller B (332) that it has the capability to perform data collation services, and that it also has the capability to execute ML algorithms. Accordingly, service controller B (332) assigns the data collation and ML algorithm execution portions of the workflow to platform controller B (324). Service controller B (332) also determines that platform controller C (326) has expressed by way of service controller C (334) that domain C (306) has video data for training the relevant ML algorithm, and the computing resources to perform the training. Service controller B (332) then determines that platform controller D (328), by way of service controller D (336), that domain D (308) has the capability of storing ML algorithm execution results, and making updates of the self-driving cars based on the ML algorithm execution results.

Based on the above results gained from searching within the graph structure maintained by the service controllers of federated controller (338), service controller B (332) provides the various workflow portions and workflow information to the appropriate platform controllers to perform the workflow portions.

Once assigned, platform controller A (322) identifies an output intent included in workflow information obtained from service controller B (332). Platform controller A further identifies a data transformation associated with the output intent. The data transformation includes realigning data generated using a central processing unit (CPU) within domain a to be compatible with graphics processing units (GPUs) that will use the data to generate ML algorithm predictions. Platform controller A (322) further determines that domain A (302) is able to perform the data transformation based on capability and capacity information associated with domain A (302). In response to the determination, platform controller A (322) configures devices of domain A (302) to perform the portion of the workflow associated with video data acquisition (i.e., the cameras (312)) and to perform data transformation services (i.e., client data transformer (314).

Platform controller B (324) identifies an output intent included in the workflow information obtained from service controller A (330) and determines that the output intent is not associated with a data transformation. Accordingly, platform controller B (332) provisions data collater (316) to perform data collation and provisions ML algorithm execution device (318) to execute the ML algorithm.

Platform controller C (326) identifies an output intent included in the workflow information obtained from service controller A (330) and determines that the output intent is not associated with a data transformation. Accordingly, platform controller C (326) provisions the set of devices to perform the workflow portion of ML algorithm training and connects the devices to the appropriate training data set to use during the training. The devices and data are shown collectively in FIG. 3 as ML training devices and data (320).

Platform controller D (328) identifies an output intent included in the workflow information obtained from service controller A (330) and determines that the output intent is not associated with a data transformation. Accordingly, platform controller D (328). Accordingly, platform controller D (328) provisions storage within the ML results datastore (350) to store the results of the execution of the ML algorithm.

As the various workflow portions get deployed in the appropriate locations in the ecosystem, execution begins. First, the ML algorithm is trained using the car manufacturer's existing labeled video data in ML training devices and data (320) of domain C (306). Once the algorithm is sufficiently trained, the trained algorithm is provided over network (340) to ML algorithm execution device (318) of domain B (304). At that point, cameras (312) in domain A (302) begin capturing videos of events occurred by the self-driving car. The video data is transformed by the client data transformer (314) as part of the data transformation services to realign the video data to be compatible with GPUs of domain B (304). The transformed video data is transmitted to data collater (316), which collates the video data and provides the video data to ML algorithm execution device (318). ML algorithm execution device (318) then executes the ML algorithm using the videos to determine if the self-driving car needs to be updated. The results are then sent to the ML results datastore (350) of domain D (308). An update module (not shown) also in domain D (308) accesses the results, and performs the necessary software updates.

In the above example, the graph construct representing the capabilities and capacity of the various domains was used to quickly and automatically determine where to place workflow portions based on the requirements, constraints, and capabilities learned by decomposing the DAG of the workflow. Once the workflow portions were provided to the platform controllers, the platform controllers were able to identify data transformations associated with portions of the workflow based on output intent, and thus provision workflows with data transformation services, thereby proactively performing data transformation services before transmitting data to other domains and/or devices within a domain, improving the efficiency of executing workflow portions in complex device ecosystems and reducing the likelihood execution would fail, or fail to meet the SLA associated with the workflow.

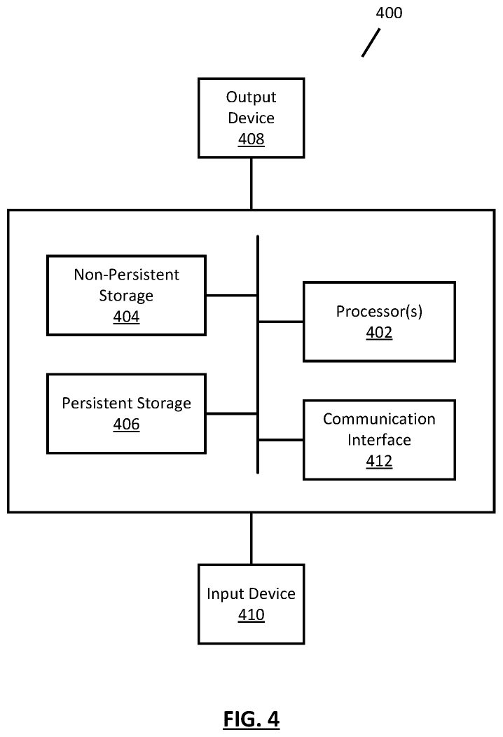

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disc (CD) drive or digital versatile disc (DVD) drive, a flash memory, etc.), a communication interface (412) (e.g., Bluetooth® interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

Embodiments described herein use several layers of a graph or database as a mechanism to manage the ecosystem at scale using algorithms and techniques for provisioning workflows with proactive data transformation. In one or more embodiments, decomposing workflows into workflow portions includes generating workflow information that includes output intent. When provided to platform controllers, the output intent enables the platform controllers to proactively provision data transformation services when provisioning workflow portions. Proactively provisioning data transformations may increase the efficiency of executing workflow portions, increase the likelihood of meeting the SLA for the workflow, and reduce the computational burden of executing workflow portions. Such benefits may be achieved by performing data transformation at domains or devices executing workflow portions that generate and/or otherwise obtain the data instead of at domains and devices that perform services using the data.

The problems discussed above should be understood as being examples of problems solved by embodiments of the invention, and the invention should not be limited to solving the same/similar problems. The disclosed invention is broadly applicable to address a range of problems beyond those discussed herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for provisioning workflows with data transformation services, the method comprising:
receiving, by a platform controller associated with a first domain, workflow information associated with a portion of a workflow to be deployed in a device ecosystem, wherein the portion of the workflow comprises a first subportion of the workflow;
identifying an output intent associated with data of the first subportion of the workflow;
making a first determination that the output intent is associated with a data transformation of the data; and
in response to the first determination:
making a second determination that the first domain is able to perform the data transformation;
in response to the second determination:
establishing data transformation services using resources of the first domain; and
initiating performance of the first subportion of the workflow, wherein executing the first subportion of the workflow comprises executing the data transformation services.

2. The method of claim 1, wherein the workflow information specifies the output intent.

3. The method of claim 2, wherein the portion of the workflow further comprises a second subportion of the workflow, wherein the output intent specifies services of the second subportion of the workflow to be performed on the data obtained as a result of the performance of the first subportion of the workflow.

4. The method of claim 3, wherein the first subportion of the workflow is performed by resources of the first domain and the second subportion of the workflow is performed by the resources of the first domain.

5. The method of claim 3, wherein the first domain is part of a plurality of domains that further comprises a second domain, wherein the first subportion of the workflow is performed by resources of the first domain and the second subportion of the workflow is performed by resources of the second domain.

6. The method of claim 3, wherein executing the data transformation services comprises transforming the data obtained from the first subportion of the workflow to generate transformed data.

7. The method of claim 6, wherein the transformed data is used in the performance of the second subportion of the workflow.

8. A non-transitory computer readable medium comprising computer readable program code, which when executed by a computer processor enables the computer processor to perform a method for provisioning workflows with data transformation services, the method comprising:
receiving, by a platform controller associated with a first domain, workflow information associated with a portion of a workflow to be deployed in a device ecosystem, wherein the portion of the workflow comprises a first subportion of the workflow;
identifying an output intent associated with data of the first subportion of the workflow;
making a first determination that the output intent is associated with a data transformation of the data; and
in response to the first determination:
making a second determination that the first domain is able to perform the data transformation;
in response to the second determination:
establishing data transformation services using resources of the first domain; and
initiating performance of the first subportion of the workflow, wherein executing the first subportion of the workflow comprises executing the data transformation services.

9. The non-transitory computer readable medium of claim 8, wherein the workflow information specifies the output intent.

10. The non-transitory computer readable medium of claim 9, wherein the portion of the workflow further comprises a second subportion of the workflow, wherein the output intent specifies services of the second subportion of the workflow to be performed on the data obtained as a result of the performance of the first subportion of the workflow.

11. The non-transitory computer readable medium of claim 10, wherein the first subportion of the workflow is performed by resources of the first domain and the second subportion of the workflow is performed by the resources of the first domain.

12. The non-transitory computer readable medium of claim 10, wherein the first domain is part of a plurality of domains that further comprises a second domain, wherein the first subportion of the workflow is performed by resources of the first domain and the second subportion of the workflow is performed by resources of the second domain.

13. The non-transitory computer readable medium of claim 10, wherein executing the data transformation services comprises transforming the data obtained from the first subportion of the workflow to generate transformed data.

14. The non-transitory computer readable medium of claim 13, wherein the transformed data is used in the performance of the second subportion of the workflow.

15. A system for provisioning workflows with data transformation services, the system comprising:
a service controller of a federated controller for a device ecosystem;
a platform controller of a first domain, comprising a processor and memory, and configured to:
receive, from the service controller, workflow information associated with a portion of a workflow to be deployed in the device ecosystem, wherein the portion of the workflow comprises a first subportion of the workflow;
identify an output intent associated with data of the first subportion of the workflow;
make a first determination that the output intent is associated with a data transformation of the data; and
in response to the first determination:
make a second determination that the first domain is able to perform the data transformation;
in response to the second determination:
establish data transformation services using resources of the first domain; and
initiate performance of the first subportion of the workflow, wherein executing the first subportion of the workflow comprises executing the data transformation services.

16. The system of claim 15, wherein the workflow information specifies the output intent.

17. The system of claim 16, wherein the portion of the workflow further comprises a second subportion of the workflow, wherein the output intent specifies services of the second subportion of the workflow to be performed on the data obtained as a result of the performance of the first subportion of the workflow.

18. The system of claim 17, wherein the first subportion of the workflow is performed by resources of the first domain and the second subportion of the workflow is performed by the resources of the first domain.

19. The system of claim 17, wherein the first domain is part of a plurality of domains that further comprises a second domain, wherein the first subportion of the workflow is performed by resources of the first domain and the second subportion of the workflow is performed by resources of the second domain.

20. The system of claim 17, wherein executing the data transformation services comprises transforming the data obtained from the first subportion of the workflow to generate transformed data.
